(19) United States
(12) Patent Application Publication
(10) Pub. No.: US 2020/0298153 A1
(43) Pub. Date: Sep. 24, 2020

(54) SYSTEM AND RELATED METHODS FOR FABRICATION OF WIRE BASED SCREEN FILTERS

(71) Applicant: Aqseptence Group, Inc., New Brighton, MN (US)

(72) Inventor: Michael Richard Ekholm, Minneapolis, MN (US)

(73) Assignee: Aqseptence Group, Inc., New Brighton, MN (US)

(21) Appl. No.: 16/652,335

(22) PCT Filed: Sep. 28, 2018
(86) PCT No.: PCT/US2018/053297

§ 371 Date: Mar. 30, 2020

Related U.S. Application Data
(60) Provisional application No. 62/564,762, filed on Sep. 28, 2017.

(51) Int. Cl. B01D 39/12; B23K 31/02

(52) U.S. Cl. CPC B01D 39/12; B01D 2239/10; B23K 31/02

(57) ABSTRACT

A screen filter fabrication machine configured to produce a screen filter having a controlled slot width between wires. The screen filter fabrication machine can include a frame, a tooling head configured to rotate relative to the frame and retain a plurality of support rods, a wire feed wheel operably coupled to the frame and configured to dispense wire as it is wound around the plurality of support rods, and a control system configured to monitor one or more parameters concerning the slot width, and implement one or more process control adjustments configured to enable the winding of the wire around the plurality of support rods in such a manner that at least 99.7% of a measured slot width during screen filter fabrication falls within three standard deviations of a mean slot width measured during screen filter fabrication.

### FIELD OF THE DISCLOSURE

The present disclosure relates to a screen filter fabrication machine for fabricating wire based screen filters for separating solid matter from fluid streams. More particularly, the present disclosure is directed to a screen filter fabrication machine having a control system configured to monitor one or more parameters and implement one or more process control adjustments to affect a more uniform slot width between wires.

### BACKGROUND OF THE DISCLOSURE

Screens fabricated from welded wires have been utilized for a variety of purposes since early in the 20th century. One of the most popular uses has been as a liquid separation instrument or filter to remove solids from liquids or as a gas separation instrument for removing solids or suspended liquids from gases. Representative liquids can include fresh or salt water as well as various aqueous and non-aqueous liquid process streams found in a variety of industries. More recently, wire-based screens have even been utilized as architectural components so as to provide unique aesthetic appearances to the exterior of buildings and other public structures. Regardless of the particular use, the fabrication techniques are similar for screens in each of these applications.

In the context of solid/liquid separation, one frequent application for wire-based screen filters is as part of a water intake system. These water intake systems typically use an inlet pipe adapted to transport water from a position submerged in a body of water to the end-user adjacent to the body of water. An inlet pipe is submerged in the body of water and the end of the inlet pipe is typically coupled to an intake filter assembly configured to inhibit waterborne debris and aquatic life, of a certain size, from entering the inlet pipe. Water intake systems are typically used to provide water to end-users such as manufacturing plants, cities, irrigation systems, and power generation facilities located adjacent to a body of water such as a river, lake, or salt water bodies. The end user may employ this type of system as an alternative to drilling a well or buying water from a municipality. Additionally, use of these systems may be determined by the location of the end-user, for example remote locations where water from a municipal source and/or electrical power to operate pumps is not readily available. These water collection systems have the ability to adapt to various conditions and deliver water efficiently and economically.

In many water intake systems, the inlet pipe will include an intake filter assembly that incorporates a wire-based screen to prevent particulate matter from entering the water intake system. Due to their robust strength, the wire-based screen allows the intake filter assembly to be repeatably cleaned, backwashed and or flushed so as to extend the life of the intake filter assembly. As such, costs associated with plugging, replacement and disposal common to other types of intake filters, such as conventional bag, cartridge, ceramic, hollow fiber, and membrane filters, can be avoided. These same advantages extend to the use of wire-based screens in industrial processes, which can lead to increase process uptime and lower production costs.

While the current state of the art in wire-based screens provides a number for many processing advantages, it would be advantageous to further improve upon the manufacturing techniques so as to improve screen consistency and reduce production waste. In particular, it would be advantageous to develop techniques that provide for the manufacturing of wire-based screens having reduced variability during construction such that variability in gap width between adjacent wires is reduced.

### SUMMARY OF THE INVENTION

Embodiments of the present disclosure provide a screen filter fabrication machine configured to fabricate a screen filter with a higher level of consistency in gap width, such that the filter can be used to target and/or remove particulate matter having above a desired particulate size that is greater than the gap opening. One representative embodiment of the present disclosure provides a screen filter fabrication machine including a frame, a tooling head configured to rotate relative to the frame and retain a plurality of support rods, a wire feed wheel operably coupled to the frame and configured to dispense wire, and a control system configured to monitor one or more parameters concerning the slot width, and implement one or more process control adjustments configured to enable the winding of the wire around the plurality of support rods in such a manner that at least 99.7% of a measured slot width during screen filter fabrication falls within three standard deviations of a mean slot width measured during screen filter fabrication.

The above summary is not intended to describe each illustrated embodiment or every implementation of the subject matter hereof. The figures and the detailed description that follow more particularly exemplify various embodiments.

### BRIEF DESCRIPTION OF THE FIGURES

Subject matter hereof may be more completely understood in consideration of the following detailed description of various embodiments in connection with the accompanying figures, in which:

FIG. 1 is a perspective, end view depicting a screen filter in accordance with an embodiment of the disclosure.

FIG. 2 is an end view depicting the screen filter of FIG. 1.

FIG. 3 is a partial, cross-sectional view depicting a screen filter in accordance with an embodiment of the disclosure.

FIG. 4A is a partial, profile view depicting a spiral wrapping of wire in the form of a cylindrical body in accordance with an embodiment of the disclosure.

FIG. 4B is a partial, perspective view depicting a spiral wrapping of wire in the form of a cylindrical body in accordance with an embodiment of the disclosure.

FIG. 5 is a schematic view depicting a screen filter fabrication machine in accordance with an embodiment of the disclosure.

FIG. 6 is a schematic view depicting an alternative embodiment of a screen filter fabrication machine in accordance with the disclosure.

FIG. 7 is a process flow diagram for actively monitoring and controlling a slot width of a screen filter during fabrication in accordance with an embodiment of the disclosure.

FIG. 8 is a schematic for a fabrication machine performing the process of FIG. 7 in accordance with an embodiment of the disclosure.

FIG. 9 is a bell curve illustrating a normal distribution of a monitored slot width along a length of cylindrical body of a screen filter in accordance with an embodiment of the disclosure.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE INVENTION

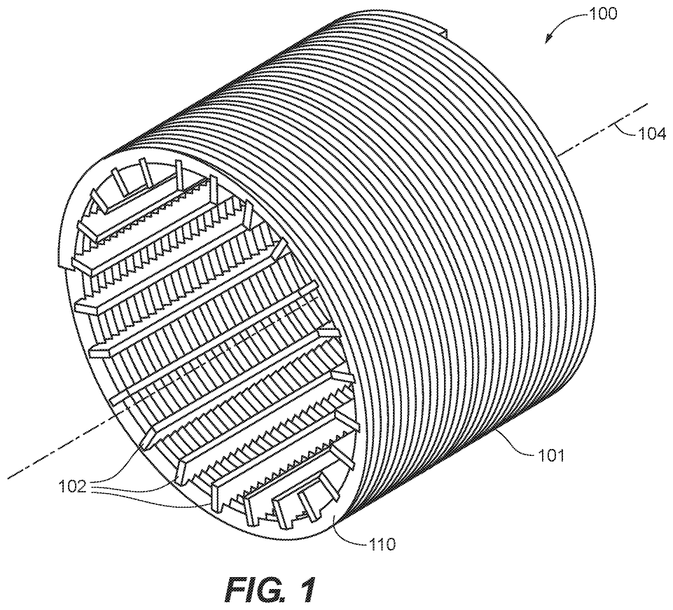

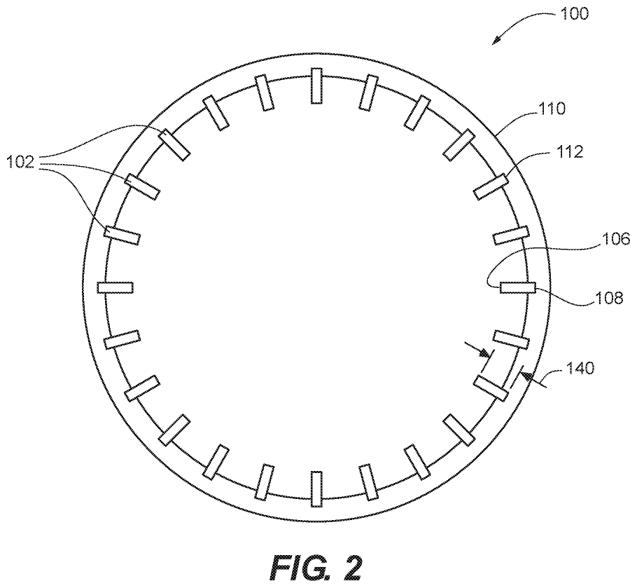

Referring to FIGS. 1 and 2, a screen filter 100 is depicted in accordance with an embodiment of the disclosure. In one embodiment, the screen filter 100 can be fabricated to assume a cylindrical body 101. Alternatively, the screen filter 100 can be fabricated so as to assume a flat screen, whereby two or more flat screens can be operably coupled to assume other geometric configurations. Screen filter 100 is generally fabricated from suitable metallic materials and alloys including, for example, stainless steel, titanium, copper-nickel alloys, and the like. Material selection can be dependent on compatibility characteristics with a fluid to be filtered or based upon other process variables. Other nonmetallic materials including, for example, PVC, that have properties enabling fabrication with similar geometries having similar gap widths and precision can also be used in potential embodiments of the disclosure.

In one embodiment, the screen filter 100 can include a plurality of support rods 102. The support rods 102 can be evenly spaced and arranged in parallel relation to a longitudinal axis 104 of the screen filter 100. As best depicted in FIG. 2, each support rod 102 can include an interior surface 106 and an exterior surface 108, so as to define a support rod height 140 there between. A continuous length of wire 110 can be wound about the support rods 102, such that the wire 110 can be affixed to the exterior surface 108 at each point of contact 112. As the wire is continually wound and spiraled about the support rods 102, the cylindrical body 101 is generally defined for the screen filter 100.

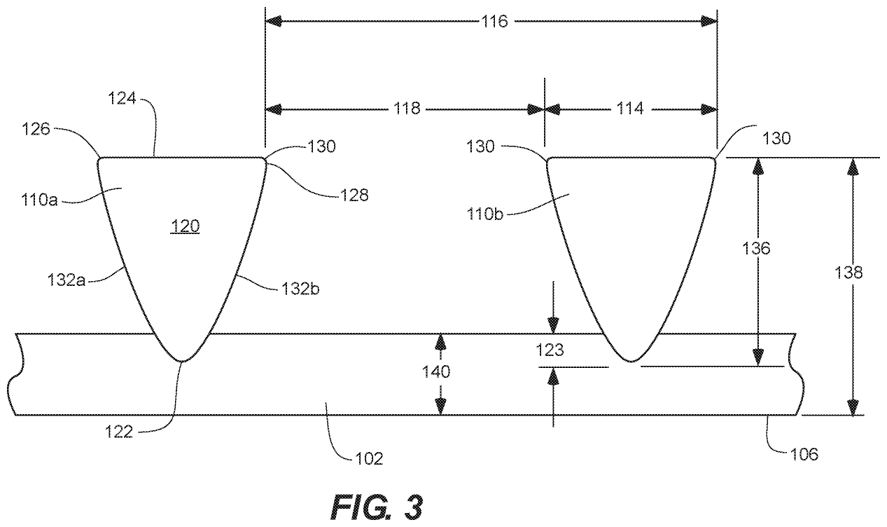

Referring to FIG. 3, a section view of a screen filter 100 is depicted in accordance with an embodiment of the disclosure. In one embodiment, the wire 110 has a triangular cross section 120, commonly referred to in the industry as Vee-Wire®. While wire 110 having a triangular cross section 120 is preferred, the use of other conventional wire profiles known in the art is also contemplated. As depicted, the wire 110 can have a first vertex 122 affixed to the support rod 102 at the point of contact 112. The first vertex 122 can be operably coupled to the support rod 102 using a suitable technique, such as electrical resistance welding, ultrasonic bonding or other fusing/attachment methods known in the art. As the weld is completed at each point of contact 112, a penetration depth 123 is defined in the wire 110 and/or support rod 102.

Opposite to the first vertex 122, is an exposed wire surface 124 having a wire width 114 defined between a second vertex 126 and a third vertex 128. The second vertex 126 and the third vertex 128 can each define a corner radius 130. A pair of relief surfaces 132a, 132b can extend between the first vertex 122 and the second and third vertices 126, 128 respectively. A wire height 136 can be defined between the first vertex 122 and the exposed wire surface 124. When the wire 110 is operably coupled to the support rod 102, and overall screen height 138 is generally defined between the interior surface 106 and the exposed wire surface 124. The screen height 138 is generally equivalent to the sum of the wire height 136 and the support rod height 140, minus the penetration depth 123. The spiral wrapping and welding of the wire 110 about the support rods 102 results in a repeating pattern of adjacent wires 110a, 110b.

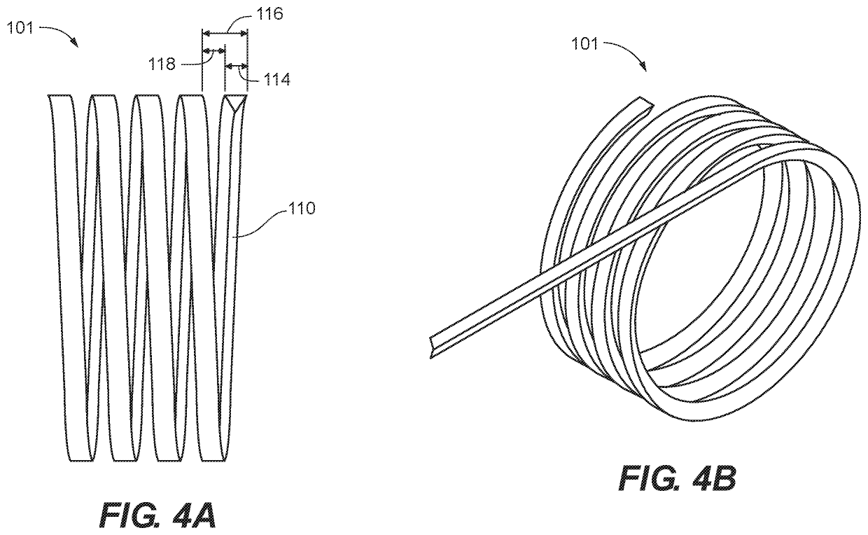

Referring to FIGS. 4A-B, for improved clarity, a portion of the spiral wrapping of wire 110 in the form of a cylindrical body 101 is depicted without the support rods. In forming the cylindrical body 101, the wire 110 can be wound around the support rods 102 at a given pitch 116, so as to define a slot having a measurable slot width 118. As best depicted in FIG. 3, the slot width 118 can be defined between the opposing corner radii 130 of adjacent wires 110a, 110b, whereas the pitch can defined between the same corner radii 130 of adjacent wires 110a, 110b.

In some embodiments, it may be desirable to “reverse” the attachment of the wire 110 to the support rod 102, such that the exposed wire surface 124 is affixed to the support rod 102 such that the slot width 118 is defined proximate to the support rod 102 and is inwardly facing toward a center of the cylindrical body 101. Additionally, depending upon the overall size of the screen filter 100, for example, the desired diameter and/or length of the cylindrical body 101, the wire 110 can comprise two more lengths or spools of wire 110 that have been joined together, such that the spiral winding of the wire 110 about the support rods 102 is continuous. In some embodiments, the cylindrical body 101 can be cut, sheared or otherwise reformed into a flat screen or into other alternative screen shapes. In addition, the screen filter 100 can include additional attachment or framing elements such as, for example, rings, fittings, bards, and other like devices to aid in mounting the screen filter 100 and the desired application.

In some embodiments, the pitch 116 and/or penetration depth 123 of the wire 110 can be varied during fabrication to achieve a more uniform slot width 118. For example, in one embodiment, one or more quality control measurements can be taken during the fabrication process, and used to provide feedback in the control and positioning of adjacent wires 110a, 110b, and/or the attachment of the wire 110 to the support rod 102, so as to reduce the maximum deviation along the slot width 118 within a cylindrical body 101. Accordingly, the screen filter 100 of the present disclosure is generally fabricated such that the slot width 118 is uniform and consistently defined between each of the adjacent wires 110a, 110b along a length of the cylindrical body 101. In some embodiments, consistency in the measurable slot width 118 can be such that the screen filter 100 can reliably be used to remove particulate matter having a particulate size of 10 μm or less.

In some embodiments, it may be desirable to vary a “tilt” of the wire 110 relative to the support rods 102. In these situations, the exposed wire surface 124 between adjacent wraps of the wire 110 will not reside in the same plane intentionally, nor will they be parallel to plane of the support rods 102. In some instances, the exposed wire surface 124 between adjacent wraps of wire 110 will reside in a parallel orientation. It will be understood that depending upon the specific design of screen filter 100, the “tilt” of the wire 110 may be intentionally varied throughout the construction of a single screen filter 100.

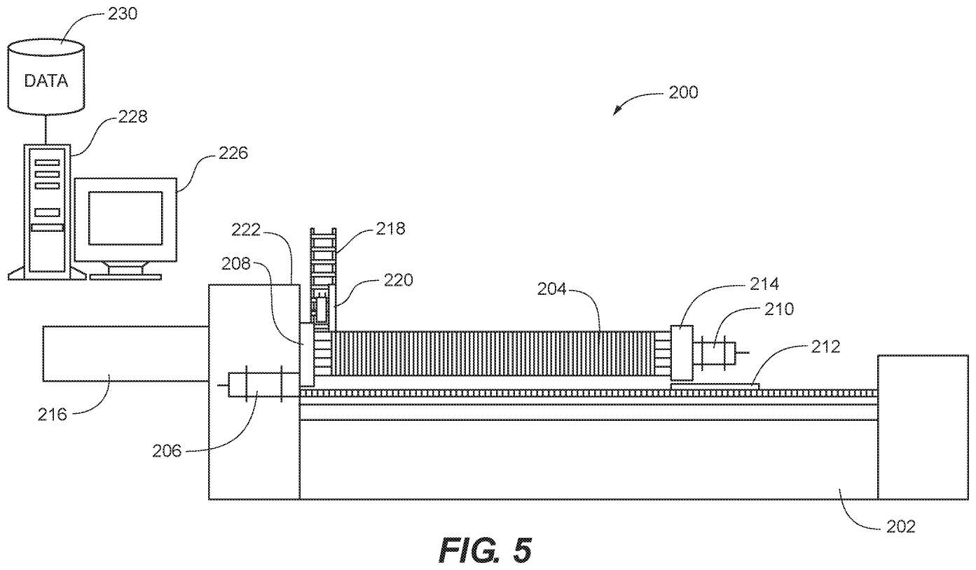

Referring to FIG. 5, a screen filter fabrication machine 200, configured to fabricate screen filters 100, is depicted in accordance with an embodiment of the disclosure. The screen filter fabrication machine 200 can include a frame 202 and a tooling head 204 configured to hold a plurality of supporting rods 102 and rotate relative to the frame 202 as the wire 110 is wound around the supporting rods 102 during the fabrication process. In one embodiment, rotation of the tooling head 204 can be powered by a motor 206, either directly or via a mechanical gear assembly 208. The tooling head 202 can be supported at an end opposite by a tailstock bearing assembly 210.

The plurality of supporting rods 102 can be operably coupled to the tooling head 204 via a pull ring 214, such that the pull ring 214 is configured to pull the supporting rods 102 through the screen filter fabrication machine 200, as the wire 110 is wound around the supporting rods 102. Prior to being wound with wire 110, the plurality of supporting rods 102 can be supported by a rod holder 216. A wire feed wheel 218 can be positioned in proximity to the tooling head 204, and can be configured to dispense wire 110 as it is wound around the supporting rods 102. A wire feed guide 220 can further aid in positioning the wire 110 relative to the supporting rods 102 during fabrication. In some embodiments, the tension of wire 110 can be controlled via the wire feed wheel 218, as it is wound around the supporting rods 102, so as to affect the proper penetration depth 123 of the wire 110 relative to the supporting rods 102.

In some embodiments, an electrical current generated by an electrical current source 222 can be applied to the wire 110, while the plurality of supporting rods 102 can be in electrical communication with an electrical ground. Accordingly, in some embodiments, the electrical current applied to wire 110 can cause the wire 110 to bond to one of the plurality of supporting rods 102 when the wire 110 and the supporting rod 102 make contact, thereby causing the wire 110 to fuse or to be welded to the supporting rod 102. In some embodiments, only the supporting rod 102 closest to the wire feed guide 222 can be grounded, so as to establish a clear path of least resistance. In some embodiments, the electrical current can be alternated on and off, such that electrical current is only applied when needed. In some embodiments, the magnitude of electrical current can be controlled by the electrical current source 222, so as to affect the proper penetration depth 123 of the wire 110 relative to the supporting rods 102.

In some embodiments, the tooling head 204 can be configured to move laterally along the axis of rotation relative to the frame 202, so as to provide the proper pitch 116 between adjacent wires 110a, 110b as the wire 110 is wound around the supporting rods 102. In one embodiment, a rotary screw 212 is employed to affect the lateral movement; however, the use of other mechanisms known in the art to affect lateral movement is also contemplated. In one embodiment, the lateral movement of the tooling head 204 relative to the frame 202 can be controlled, so as to achieve the desired slot width 118 between adjacent wires 110a, 110b. Additionally, in one embodiment, the rotation of the tooling head 204 relative to the frame 202 can be controlled, so as to achieve the desired penetration depth 123 of the wire 110 relative to the supporting rods 102 and/or the desired slot width 118 between adjacent wires 110a, 110b during the fabrication process.

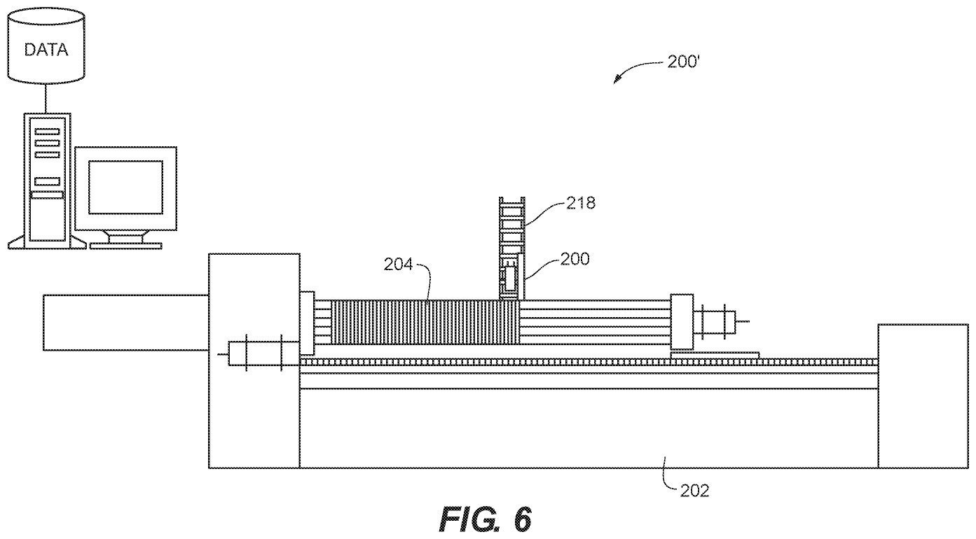

Referring to FIG. 6, in an alternative embodiment of a screen filter fabrication machine 200′, rather than laterally shifting the tooling head 202 relative to the frame 202, the wire feed wheel 218 and wire feed guide 220 can be configured to shift laterally relative to the frame 202. In this embodiment, at least one of the rotation of the tooling head 204, the magnitude of electrical current via the electrical current source 222, the tension of wire 110 via the wire feed wheel 218, and the lateral position of the wire feed wheel 218 and wire feed guide 220 can be controlled, so as to achieve the desired penetration depth 123 of the wire 110 relative to the supporting rods 102 and/or the desired slot width 118 between adjacent wires 110a, 110b during the fabrication process.

Referring again to FIG. 5, in one embodiment, the screen filter fabrication machine, can include a control system 224, having a display 226, a computer 228 operably coupled to and in communication with one or more sensors configured to monitor one or more parameters concerning the slot width, and a storage unit 230 configured to store information or data gathered by the one or more sensors. Computer 228 generally comprises a suitable processor and operating system while storage unit 230 includes memory appropriate for interfacing with the computer processor.

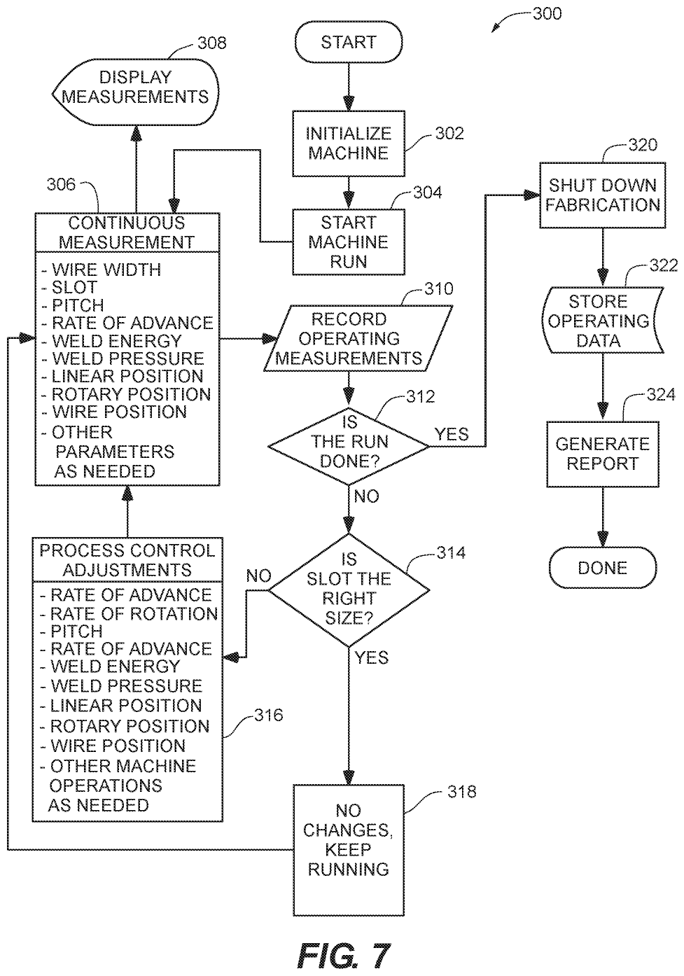

Referring to FIG. 7, a process 300 for actively monitoring and controlling the slot width 118 during the fabrication of a screen filter 100 is depicted in accordance with an embodiment of the disclosure. At 302, the screen filter fabrication machine 200 is initialized. Fabrication machine 200 is loaded with the appropriate number of supporting rods 102 and wire 110 for fabrication of a screen filter 100. At 304, the fabrication machine 200 begins fabricating the screen filter 100, by rotating the tooling head 204 to affect winding of the wire 110 around the plurality of supporting rods 102.

At 306, during fabrication, one or more parameters concerning the quality of the screen filter 100, or components thereof, are sensed or monitored. In one embodiment, the parameters concerning the quality of the screen filter 100 include at least one of the (1) wire width 114, (2) pitch 116, (3) slot width 118, (4) rate of advance (e.g., lateral shift of the tooling head 202 and/or wire feed wheel 218 relative to the frame 202), (5) magnitude of the weld energy (e.g., electrical current supplied via the electrical current source 222), (6) weld pressure (e.g., tension in the wire 110 affected by the wire feed wheel 218 and/or the rotation of the tooling head 204 relative to the frame 202), (7) linear position of the tooling head 204 and/or wire feed wheel 218 relative to the frame 202, (8) rotary position of the tooling head 204 relative to the frame 202, (9) wire position (e.g., the position of the wire feed wheel 218 relative to the tooling head 204), and (10) other parameters as needed. At 308, one or more of the measured parameters can be displayed. In one embodiment, the one or more parameters can be monitored continuously. In another embodiment, the frequency that the one or more parameters are monitored can be based on statistical data, or previous measurements from the monitoring of the one or more parameters. At 310, the one or more sensed to parameters is recorded.

At 312, it is queried as to whether the fabrication process is complete. If the fabrication process has not been completed, at 314, it is queried as to whether the slot width 118 is of the appropriate size and/or whether the wire surface 124 of adjacent wires 110a, 110b are in alignment. If it is determined that the slot width 118 is not the appropriate size and/or the wire surface 124 of adjacent wires 110a, 110b are not in alignment, at 316, one or more process control adjustments is made to the fabrication machine 200. In one embodiment, the process control adjustments include at least one of the: (1) pitch 216, (2) magnitude of the weld energy (e.g., electrical current supplied via the electrical current source 222), (3) weld pressure (e.g., tension in the wire 110 affected by the wire feed wheel 218 and/or the rotation of the tooling head 204 relative to the frame 202), (4) linear position of the tooling head 204 and/or wire feed wheel 218 relative to the frame 202, (5) rate of advance (e.g., the rate of lateral shifting of the tooling head 204 and/or wire feed wheel 218 relative to the frame 202), (6) rotary position of the tooling head 204 relative to the frame 202, (7) rate of rotation (e.g., the rate of the rotation of the tooling head 204 relative to the frame 202, (9) wire position (e.g., the position of the wire feed wheel 218 relative to the tooling head 202), and (10) other process control adjustments as needed. Following a process control adjustments, at 306, one or more parameters concerning the quality of the screen filter 100, or components thereof, is again sensed or monitored, and the process continues.

Alternatively, if at 314, it is determined that the slot width 118 is the appropriate size and/or the wire surface 124 of adjacent wires 110a, 110b are in alignment, at 318, no process control adjustments are made, and the process advances to 306 for the sensing of one or more parameters concerning the quality of the screen filter 100.

If at 312, it is determined that the fabrication process is completed, at 320, fabrication of the screen filter 100 is shut down. At 322, sensed parameters and/or other data collected during operation 306 can be optionally stored in a memory. At 324, optionally, the sensed parameters and/or other data collected during operation 306 can be utilized to generate a report.

It should be understood that the individual steps used in the methods of the present teachings may be performed in any order and/or simultaneously, as long as the teaching remains operable. Furthermore, it should be understood that the apparatus and methods of the present teachings can include any number, or all, of the described embodiments, as long as the teaching remains operable.

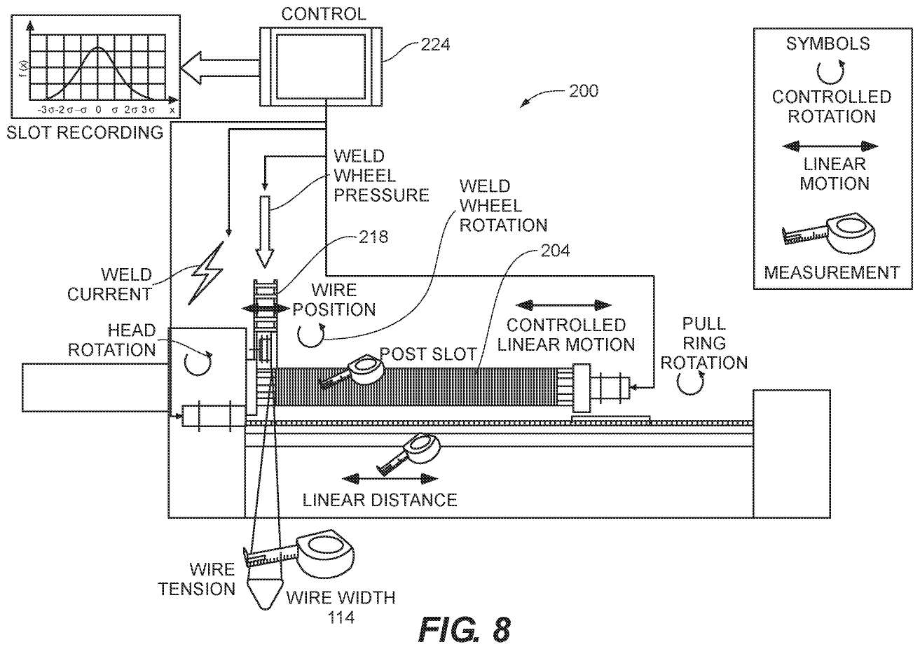

Referring to FIG. 8, a schematic of the fabrication machine 200 performing process 300 is depicted in accordance with an embodiment of the disclosure. During the process 300, the fabrication machine 200 utilizes the feedback loop defined by process 300 to sense one or more parameters concerning the quality of the screen filter 100, to affect a control of at least one of rotation of the tooling head 204, the magnitude of electrical current via the electrical current source 222, the tension of wire 110 via the wire feed wheel 218, and/or the lateral position of the tooling head 204 and/or the wire feed wheel 218 and wire feed guide 220, so as to achieve the desired penetration depth 123 of the wire 110 relative to the supporting rods 102 and/or the desired slot width 118 between adjacent wires 110a, 110b.

Accordingly, in one example embodiment, the wire width 114 of wire 110 could be measured by the fabrication machine 200 as it is dispensed from the wire feed wheel 218. If the wire width 114 is determined to be smaller than the mean wire width 114, one or more process control adjustments can be made. For example, the linear position of the tooling head 204 and/or wire feed wheel 218 relative to the frame 202 can be adjusted to compensate for the smaller wire width 114 to achieve the appropriate slot width 118, and the magnitude of the weld energy (e.g., electrical current supplied via the electrical current source 222) can be adjusted to achieve the appropriate penetration depth 123. Other process control adjustments can be made as desired/needed to affect the desired characteristics of the screen filter 100 during fabrication.

In one embodiment, if the sensed wire width 114 is within a first predefined range, a first set of process control adjustments can be made. If the sensed wire width 114 is outside of the first predefined range, but within a second predefined range, a second set of process control adjustments, which can include the first set of process control adjustments plus additional process control adjustments, can be made. If the sensed wire width 114 is outside of the second predefined range, an operator of the fabrication machine 200 can be alerted via the display measurements, and the process 300 can be halted until appropriate corrections can be made.

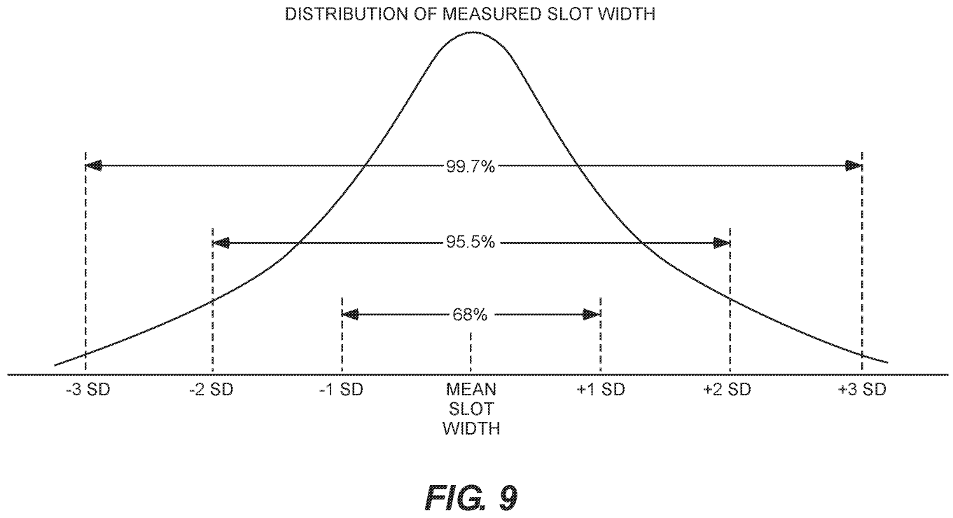

Referring to FIG. 9, a bell curve illustrating a normal distribution of the monitored slot width 118 along a length of the cylindrical body 101 of a screen filter 100 is depicted in accordance with an embodiment of the disclosure. As illustrated, 68% of the slot width 118, as measured circumferentially around the cylindrical body 101, is within one standard deviation of the mean slot width 118, 95.5% of the measured slot width 118 is within two standard deviations of the mean slot width 118, and 99.7% of the measured slot width 118 is within three standard deviations of the mean slot width 118. Accordingly, in some embodiments, the consistency in the measured slot width 118 is such that the screen filter 100 can reliably be used to remove the desired particulate matter.

In one embodiment, data collected during operation 322 can be analyzed by the fabrication machine 200, and through a process of continually modifying different process control adjustments, for example by a Design of Experiments (DOE) process, the fabrication machine 200 can optimize characteristics of the fabricated screen filter 100.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

1. A screen filter fabrication machine configured to produce a screen filter having a controlled slot width between wires, the fabrication machine comprising:
a frame;
a tooling head configured to rotate relative to the frame and retain a plurality of support rods;
a wire feed wheel operably coupled to the frame and configured to dispense a wire; and
a control system configured to monitor one or more parameters concerning the slot width, and implement one or more process control adjustments configured to enable the winding of the wire around the plurality of support rods in such a manner that at least 99.7% of a measured slot width during screen filter fabrication falls within three standard deviations of a mean slot width measured during screen filter fabrication.

2. The screen filter fabrication machine of claim 1, further comprising a display configured to display the one or more monitored parameters concerning the slot width.

3. The screen filter fabrication machine of claim 1, wherein the one or more process control adjustments are changed in response to the monitored one or more parameters concerning the slot width.

4. The screen filter fabrication machine of claim 1, wherein information derived from the monitoring of the one or more parameters concerning the slot width is utilized in the implementation of the one or more process control adjustments in a feedback loop.

5. The screen filter fabrication machine of claim 1, wherein the one or more of parameters concerning the quality of the screen filter is at least one of the slot width, a wire width, a wire pitch, a rate of advance of the tooling head relative to the frame, a magnitude of an electrical weld current, a tension in the wire affected by the wire feed wheel and/or the rotation of the tooling head relative to the frame, a linear position of the tooling head and/or wire feed wheel relative to the frame, a rotary position of the tooling head relative to the frame, and position of the wire feed wheel relative to the tooling head.

6. The screen filter fabrication machine of claim 1, wherein the control system is further configured to produce a report including the measured slot width across the screen filter.

7. The screen filter fabrication machine of claim 1, wherein the one or more the process control adjustments is at least one of a wire pitch, a magnitude of an electrical weld current, a tension in the wire affected by the wire feed wheel and/or the rotation of the tooling head relative to the frame, a linear position of the tooling head and/or wire feed wheel relative to the frame, rate of lateral shifting of the tooling head and/or wire feed wheel relative to the frame, a rotary position of the tooling head relative to the frame, a rate of rotation of the tooling head relative to the frame, and a position of the wire feed wheel relative to the tooling head.

8. A real-time control system for manufacturing screen filters, comprising:
a computer processer controlling a screen filter fabrication machine, the computer configured to accept an input corresponding to a desired parameter of a screen filter to be fabricated by the screen filter fabrication machine; and
at least one sensor positioned proximate to the screen filter fabrication machine so at to measure the desired parameter of the screen filter during fabrication, said at least one sensor communicating a measurement of the desired parameter to the computer processor, whereby the computer processor is adapted to adjust a performance characteristic of the screen filter fabrication machine if the measurement of the desired parameter differs from the input of the desired parameter.

9. The real-time control system of claim 8, further comprising:
a storage unit operably coupled to the computer processor, the storage unit configured to store data related to the input of the desired parameter and the measurement of the desired parameter.

10. The real-time control system of claim 9, wherein the computer processor accesses data stored in the storage unit to compile a report related to a screen filter, the input of the desired parameter and the measurement of the desired parameter.

11. The real-time control system of claim 9, wherein the desired parameter of the screen filter is a slot width or wire alignment.

12. The real-time control system of claim 11, wherein the performance characteristic of the screen filter fabrication machine comprises one or more of a wire pitch, a magnitude of an electrical weld current, a tension in a wire affected by a wire feed wheel and/or rotation of a tooling head relative to a frame, a linear position of a tooling head and/or wire feed wheel relative to a frame, rate of lateral shifting of a tooling head and/or wire feed wheel relative to a frame, a rotary position of a tooling head relative to a frame, a rate of rotation of a tooling head relative to a frame, and a position of a wire feed wheel relative to a tooling head.

13. A method of fabricating a screen filter, comprising:
rotating a tooling head such that a length of wire is wound about a plurality of support rods;
monitoring a parameter related to performance of a screen filter as the length of wire is wound about the plurality of support rods; and
adjusting a fabrication characteristic if the monitored parameter falls outside a desired range.

14. The method of claim 13, further comprising:
storing the monitored parameters that were monitored during fabrication of the screen filter.

15. The method of claim 14, further comprising:
generating a report related to fabrication of the screen filter that includes the monitored parameters stored during fabrication.

16. The method of claim 13, wherein the parameter comprises slot width or wire alignment.

17. The method of claim 13, wherein the fabrication characteristic comprises one or more of a wire pitch, a magnitude of an electrical weld current, a tension in a wire affected by a wire feed wheel and/or rotation of a tooling head relative to a frame, a linear position of a tooling head and/or wire feed wheel relative to a frame, rate of lateral shifting of a tooling head and/or wire feed wheel relative to a frame, a rotary position of a tooling head relative to a frame, a rate of rotation of a tooling head relative to a frame, and a position of a wire feed wheel relative to a tooling head.
